(19) United States
(12) Patent Application Publication
(10) Pub. No.: US 2009/0108567 A1
(43) Pub. Date: Apr. 30, 2009

(54) Articulation limiting device for towed vehicles

(76) Inventor: James G. Robinson, Raleigh, NC (US)

Correspondence Address: James G. Robinson, 8009 Chadbourne Ct., Raleigh, NC, 27613, US

(21) Appl. No.: 11/978,447

(22) Filed: Oct. 30, 2007

(51) Int. Cl. B60D 1/24

(52) U.S. Cl. 280/504

(57) ABSTRACT

This device limits the angular rotation of a towed vehicle/trailer from jackknifing during a back-up maneuver. This device is for use on towed vehicle/trailer with a conventional hitchball type hitch comprised of a ball mount and hitchball.

The device is comprised of removable contact plate with two rearward facing sides that act as stops that limits the angler rotation of the towed vehicle's hitch coupler. The two sides of the contact plate are at an angle that is optimal for safely turning a towed vehicle.

The contact plate is held perpendicular to the base plate by two radial posts on the contact plate that mount into two mating holes in the base plate. The base plate is mounted horizontally on the underside of ball mount and secured by the hitchball and the hitchball's retaining nut.

### FIELD OF THE INVENTION

This invention relates to devices for reducing occurrences of over-articulation of a trailer attached to a towing vehicle.

### CROSS-REFERENCE TO RELATED APPLICATIONS

| | | |
|---|---|---|
| 2,222,827 | November 1940 | Zuger |
| 3,297,340 | January 1967 | Rendessy |
| 4,025,085 | May 1977 | Jacobs |
| 4,211,428 | July 1980 | Barcus |
| 4,494,765 | January 1985 | Ratsko, et al. |
| 5,531,468 | July 1996 | White |
| 5,558,351 | September 1996 | Hunter |
| 6,254,118 | July 2001 | Dudley |
| 6,854,557 | February 2005 | Deng, et al. |

### STATEMENT REGARDING FEDERALLY SPONSORED RESEARCH OR DEVELOPMENT

Not Applicable

### BACKGROUND OF THE INVENTION

When backing-up a towed trailer the possibility of jackknifing exists. Jackknifing is over-articulation between the towing vehicle and the trailer and can often cause damage to the trailer and/or towing vehicle. Jackknifing often occurs when backing the trailer or when operating the tow vehicle and trailer combination on a slippery road surface, among other situations. Various anti-jackknifing devices have been previously proposed. However, many of these devices are provided for use with semi-trailers, and not for trailers and towing vehicles having a ball mount, hitchball and detachable coupler. Many of the anti-jackknifing devices that have been intended for trailers having a detachable coupler are relatively complex and require added attachments to the towing vehicle and or trailer.

This device fills the need for a jackknife prevention device that can be used with a tow vehicle and trailer having a hitchball type connector that is very simple in design and construction.

### SUMMARY OF THE INVENTION

The novel invention disclosed herein contemplates a simple and economical auxiliary apparatus primarily designed for use with the conventional hitchball and coupler type hitches which may be found in common use on today's highways. The apparatus of the preferred embodiment is easily adapted for use with existing vehicles and trailers with a minimum expense of effort and materials.

The invention includes a horizontally mounted base plate which is suitably secured to the ball mount. This base plate can also be made as an integrated part of the ball mount. The base plate has a pair of oppositely disposed bored holes for mounting of the contact plate. The contact plate has two radial posts that mount the contact plate perpendicular to the base plate and is secured by two cotter pins. This makes contact plate removable to facilitate the connecting of the trailer to the hitchball and also allows quick and easy swapping of various contact plates for different sizes and styles of couplers.

The contact plate is a formed curved plate having two opposing horizontal sides that have an angular relationship to the couplers ball socket and sides of the coupler that act as stops, limiting the pivotal movement of the trailer.

The fore mentioned contact plate has an L-shape cross section which is an additional embodiment of this invention that may not be readily apparent. A conventional hitchball type hitch has pivotal movement in both horizontal and vertical planes. This movement in the vertical plane is caused when the tow vehicle and the trailer past over uneven surfaces, such as abutments, potholes or sloping terrain. This movement of the trailer in the vertical plane is referred to as pitch and roll. The L-shape cross section limits the contact area between the said contact plate and the vertical sides of trailer's coupler along a horizontal plane at the horizontal centerline of the hitchball allowing the coupler to move freely over the hitchball when the tow vehicle/trailer pitches or rolls, preventing damage to the said device or to the coupler.

### BRIEF DESCRIPTION OF THE DRAWINGS

FIG. 1 is a perspective view of the articulation limiting device mounted on a towing vehicle, this view also showing the coupler and tongue of a towed vehicle.

FIG. 2 is an exploded perspective view of the articulation limiting device in association to the towing vehicle and the coupler and tongue of a towed vehicle.

FIG. 3 is an exploded side perspective view of the articulation limiting device in association to the towing vehicle and the coupler and tongue of a towed vehicle.

FIG. 4 is an exploded rear view of the articulation limiting device mounted on a towing vehicle, this view also showing the coupler.

FIG. 5 is a top view of the articulation limiting device mounted on a towing vehicle, this view also showing the coupler and tongue of a towed vehicle.

FIG. 6 is a top view of the device in association with a trailer coupler and tongue, the full lines of this view showing the articulation limiting device and the broken lines showing the limited angular rotation of the towed vehicle/trailer coupler during a back-up maneuver.

FIG. 7 is an exploded perspective view of the articulation limiting device.

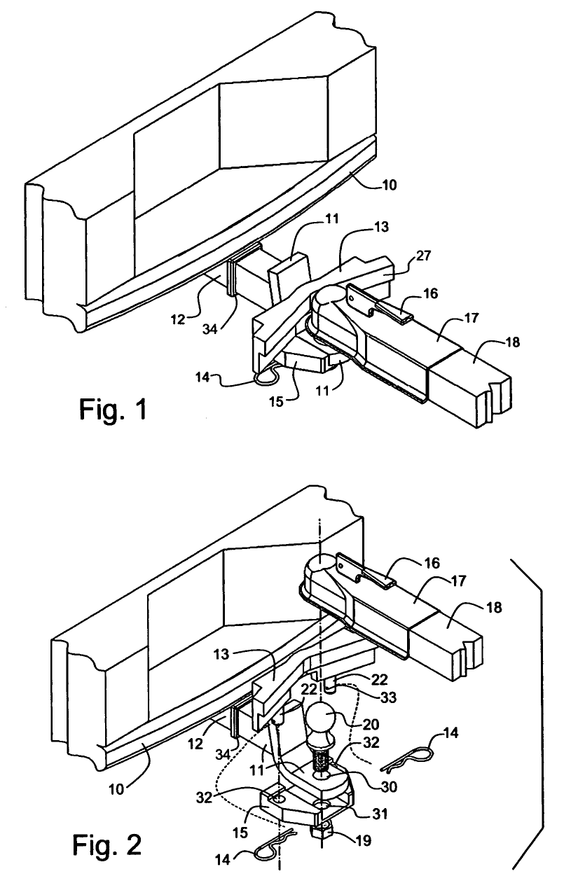

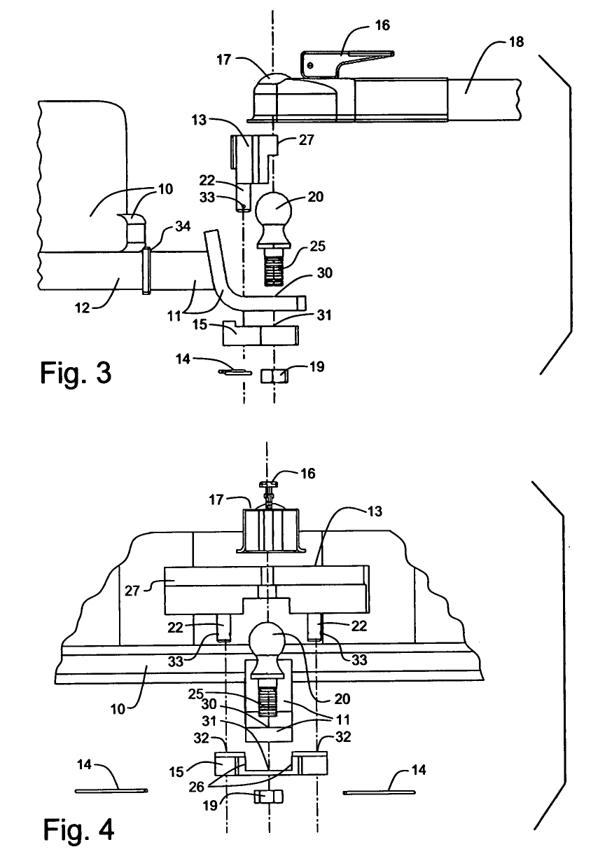

### DETAILED DESCRIPTION OF INVENTION

With particular reference to the drawings, the reference numeral 10 designates a towing vehicle which has a suitably mounted receiver hitch 12. The receiver hitch 12 has an aperture 34 for mounting the ball mount 11. All such ball mounts have a horizontal support portion having an aperture 30 for mounting of a hitchball 20.

The thread stem 25 of the hitchball 20 is mounted through aperture 30 of the ball mount 11 and aperture 31 of the base plate 15 and is fastened underneath the base plate by fastening means 19. This fastening arrangement allows the ball mount 11 to fit securely between the sidewalls 26 formed from the U-shaped channel in the base plate 15. The height of the sidewalls 26 of the integral U-shaped channel in the base plate 15 is such as to allow the coupler 17 when attached to the hitchball 20 to swing freely from side to side. Thus, this base plate 15 can remain in place when contact plate 13 is not being used.

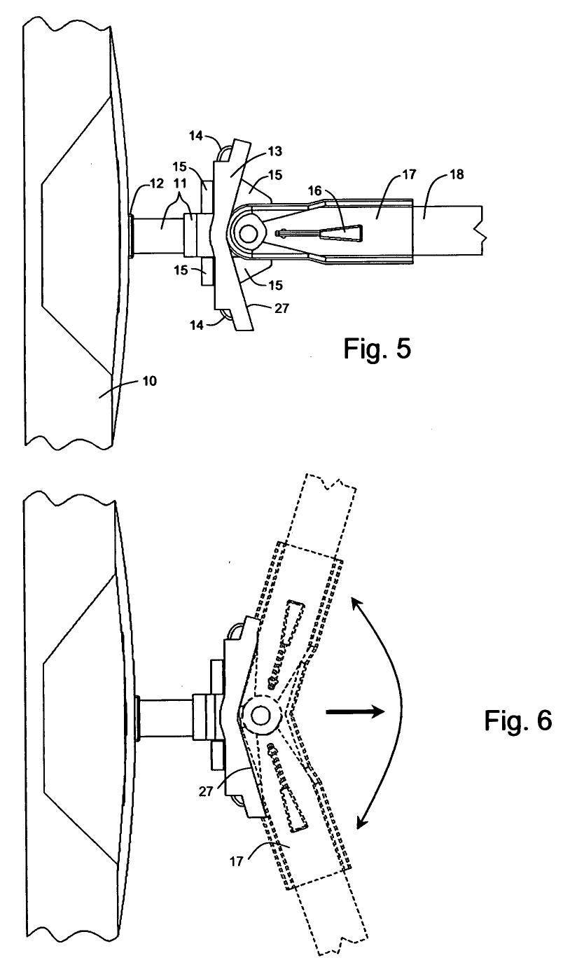

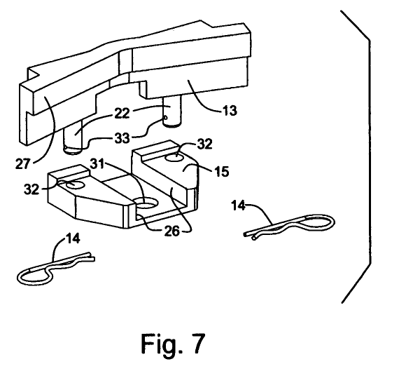

According to the invention there is contact plate 13 which has a flared U shape configuration with the widening distal ends facing toward the towed vehicle/trailer. A rib or vertically short wall 27 formed by the L-shape cross section of the contact plate 13 that extends horizontally across the face of the contact plate 13. Referring to FIGS. 5 and 6 the rib or vertically short wall 27 acts as stops that contact the coupler 17 limiting the angular rotation of the towed vehicle. The horizontal rib 27 can be metal or a suitable hardened synthetic material. The contact plate 13 has two radial posts 22 that mount into two mating bored holes 32 in the base plate 15. These radial posts 22 provide the means for mounting the contact plate 13 perpendicularly to the base plate 15 and is secured by two cotter pins 14 that fasten through two bored holes 33. The two cotter pins 14 can be easily removed allowing the contact plate 13 to be detached from the base plate 15.

The foregoing discussion disclosures and description are merely exemplary embodiments of the present invention. One skilled in the art will readily recognize from such discussion and from the accompanying drawings and claims, that various changes, modifications and variations can be made therein without departing from the spirit and scope of the invention as defined in the following claims.

What is claimed is:

1. A device for preventing over-articulation of a towing vehicle and towed vehicle/trailer having a hitchball type hitch comprised of a ball mount, hitchball and coupler. The said device is comprised of:
(a) a contact plate having two opposed sides that act as stops limiting the pivotal rotation of the towed vehicle's coupler at an angle that is the optimal for safely turning a towed vehicle during a backup maneuver and
(b) a base plate as a means of attachment of said contact plate to said ball mount.

2. The device of claim 1 whereas said contact plate comprises a flared U-shaped piece having two rearward facing sides that act as stops that limit the angler rotation of the towed vehicle/trailer's coupler at an angle optimized for safely turning a towed vehicle/trailer.

3. The device of claim 2 having an L-shaped cross section with the short wall forming a horizontal rib along the rearward facing surface of said device.

4. The device of claim 3 whereas said horizontal rib lies in a horizontal plane through the horizontal centerline axis of said hitchball.

5. The device of claim 2 having two perpendicular radial posts of suitable diameter and length to allow mounting of said device into two mating bored holes in the said base plate.

6. The device of claim 1 whereas the said base plate is mounted horizontally on the underside of the ball mount and securely fastened to the ball mount by the hitchball and hitchball retaining nut.

7. The device of claim 6 having U-shaped channel forming two vertical sidewalls of short height which allows side to side swinging movement of a trailer tongue over the top of said device when the coupler is hitched onto the hitchball.

8. The device of claim 7 whereas said vertical sidewalls are spaced at a distance apart as to allow the ball mount to fit securely between said vertical sidewalls.

9. The device of claim 6 having two bored holes of predetermined diameter as to mate with the radial pins of said contact plate.

10. The device of claim 1 having a suitable fastening means for securing said contact plate to the said base plate.

11. A device for preventing over-articulation of a towing vehicle and towed vehicle/trailer having a hitchball type hitch comprised of a ball mount, hitchball and coupler. The said device is comprised of:
(a) a contact plate having two opposed sides that act as stops limiting the pivotal rotation of the towed vehicle's coupler at an angle that is the optimal for safely turning a towed vehicle during a backup maneuver and
(b) a base plate as a means of attachment of said contact plate to said ball mount.

12. The device of claim 11 whereas said contact plate comprises a flared U-shaped piece having two rearward facing sides that act as stops that limit the angler rotation of the towed vehicle/trailer's coupler at an angle optimized for safely turning a towed vehicle/trailer.

13. The device of claim 12 has an L-shaped cross section with the short wall forming a horizontal rib along the rearward facing surface of said device.

14. The device of claim 13 whereas said horizontal rib lies in a horizontal plane through the horizontal centerline axis of said hitchball.

15. The device of claim 12 having two perpendicular radial posts of suitable diameter and length to allow mounting of said device into two mating bored holes in the said base plate.

16. The device of claim 11 whereas said base plate having two bored holes of predetermined diameter as to mate with the radial pins of said contact plate.

17. The device of claim 11 whereas said base plate is an integrated part of said ball mount.

18. The device of claim 11 having a suitable fastening means for securing said contact plate to said base plate.
